(19) United States
(12) Patent Application Publication
(10) Pub. No.: US 2015/0048009 A1
(43) Pub. Date: Feb. 19, 2015

(54) System and Method For Iron Ore Reclaiming From Tailings Of Iron Ore Mining Operations

(71) Applicant: VHIP LLC, Atlanta, GA (US)

(72) Inventor: Thomas A. Valerio, Atlanta, GA (US)

(21) Appl. No.: 14/463,403

(22) Filed: Aug. 19, 2014

Related U.S. Application Data
(60) Provisional application No. 61/867,506, filed on Aug. 19, 2013.

(51) Int. Cl. B03B 7/00; B07B 9/00; B07C 5/342; B07B 15/00

(52) U.S. Cl. CPC B03B 7/00; B07B 15/00; B07B 9/00; B07C 5/3425
USPC 209/17; 209/44; 209/30; 209/44.1

(57) ABSTRACT

A method for processing low grade iron ores includes a step of receiving iron ore tailings. The method further includes separating the iron ore tailings into two or more groups based on sizes of the iron ore tailings. Each group includes a respective portion of the iron ore tailings. The method also includes processing the portion of the iron ore tailings in at least one group using a density separation process to generate iron ore concentrate.

### CROSS-REFERENCE TO RELATED APPLICATIONS

This non-provisional patent application claims priority under 35 U.S.C. §119 to U.S. Provisional Patent Application No. 61/867,506, titled “System And Method For Iron Ore Reclaiming From Tailings Of Iron Ore Mining Operations,” filed Aug. 19, 2013, the complete disclosure of which is hereby fully incorporated herein by reference.

### TECHNICAL FIELD

The present invention generally relates to processing the lower grade iron ore deposits and, more particularly, processing the iron ore tailings byproduct of mining operations to further reclaim an iron ore product suitable for the steel-making.

### BACKGROUND OF THE INVENTION

Iron ore is an important natural resource and iron may be the world's most commonly used metal. Iron is generally extracted from iron ore rocks that contain enough metallic iron for economical extraction. The iron in iron ore is generally found in the form of magnetite, hematite, taconite, goethite, limonite, and siderite, for example. Iron ore is mainly made of iron ore oxides carrying different quantities of iron. For instance, based on the respective atomic numbers of iron (Fe)—55.84—and oxygen (O)—15.994—we see that a typical iron ore molecule of Fe2O3 carries close to 70 percent of iron by weight. Typically, ores carrying very high quantities of iron are known as natural ore or direct shipping ore, meaning that they can be fed directly to iron-making furnaces. Medium-grade iron ores with iron content between 20 percent—50 percent typically require beneficiation to increase the iron content to an appropriate level for processing or reducing into “pig iron.” Such techniques require crushing or milling the ores into fine ore or powders known as “fines” to liberate iron from other minerals and then further concentrate the iron content of such fines through silica froth flotation techniques and/or the use of conventional magnetic techniques. However, when the iron contained in the iron ore is lower than 20 percent, the typical beneficiation techniques are not economically sound to generate an iron concentrate. Such low grade iron ores can be in the form of low grade iron ore deposits or “iron ore tailings” from iron ore mining operations. This tailings byproduct from iron ore mining operations still includes valuable iron that was not conventionally recovered primarily due to economic and technological factors instead, this tailings byproduct was considered waste generated by mining operations. As one example, the Eagle Mountain Mine of southeastern California, which was the largest iron mine of the western United States from 1948-1982, generated an estimated total production of 120 million, short tons of ore, which resulted in a large quantity of iron ore tailings. These tailings were not economically suitable to further processing to remove iron because of the tailing's low iron content and limitations in technology at the time.

What is needed is a process to recover an iron ore concentrate from a low grade iron ores, or iron ore tailings produced by iron ore mining operations, in order to reduce the amount of waste and to provide a valuable resource for the economy.

### SUMMARY OF THE INVENTION

Methods and systems for cost-effectively and efficiently processing low grade iron ores, such as iron ore tailings from mining operations, are described. In one exemplary embodiment, a method for processing iron ore tailings includes the steps of (1) receiving or mining the iron ore tailings from previously mined, operations or low grade iron ore deposits; (2) sizing the low grade iron ores to separate particles having a discrete predetermined size range; (3) processing the predetermined sizes using an air separator or similar density separation process like a pulsating water density separator to generate a concentrate of iron ore suitable for the iron making; and if necessary (4) further separate the iron ore concentrate into a higher iron content ore by using color separators.

In another exemplary embodiment, a system for processing an iron ore tailings byproduct is described. The system includes a source of the iron ore tailings by product from previously mined operations; a screen that sizes the iron ore tailings to different predetermined size ‘particles to generate iron ore tailings with a specific discrete size range; a gravity separation air table or a water pulsating gravity separator for generating an iron ore concentrate fraction from each one of the different screened fractions; and, if necessary, a color sorter separator to further increase the iron content of the iron ore tailings.

### BRIEF DESCRIPTION OF THE DRAWINGS

FIG. 1 illustrates an equipment layout diagram for grade iron ore tailings processing system according to an exemplary embodiment of the present invention.

FIG. 2 illustrates an embodiment of a method of iron ore tailings processing.

### DETAILED DESCRIPTION OF EXEMPLARY EMBODIMENTS

Exemplary embodiments of the present invention provide systems and methods for processing iron ore tailings or low grade iron ore deposits to provide a remaining composition of matter comprising iron in greater proportion than in the tailings suitable for the iron-making industry.

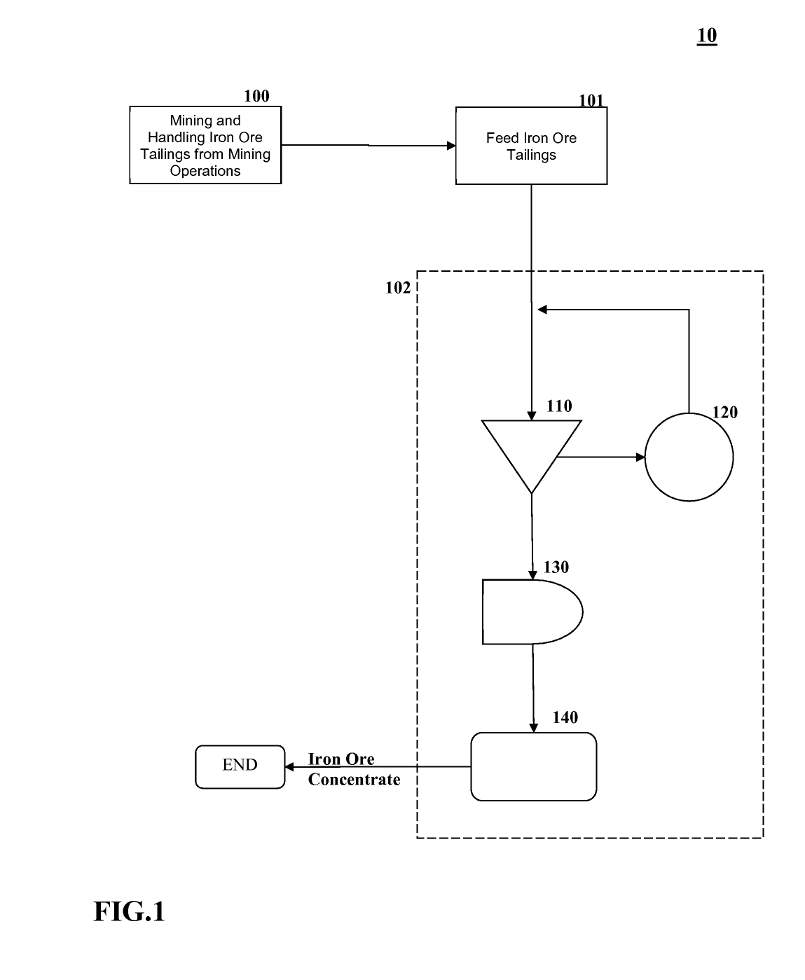

FIG. 1 illustrates an equipment layout diagram 10 for iron ore tailings processing according to certain embodiments. Referring to FIG. 1, a mining or extracting process 100 is illustrated, which includes transportation of iron ore tailings from iron ore mining operations or low grade iron ore deposits. Iron ore tailings are received 101. The iron ore tailings that are received 101 are then provided to an iron ore tailings processing system 102. In this exemplary embodiment, the iron ore tailings processing system 102 includes one or more sizing screens 110, one or more size reducers 120, and one or more density separators 130, such as vacuum or pressure gravity separation air tables and water pulsating separator. Finally, the heavy fraction from the density separator is processed through one or more color sorter separators 140 to further concentrate the iron content of the heavy fraction. From the one or more color sorter separators 140, separated iron ore, at an iron content of 50 percent or greater, is output.

It is noted that, depending upon the type of iron ore tailings that are fed into the processing system 102, the processing system 102 may or may not rely upon or include the use of certain equipment, such as the size reducer 120, or the color sorter separator 140. For example, the processed tailings may not require any further sorting after generating an iron ore concentrate on the density separators 130.

At first, the low grade iron ore deposits or tailings from previous mining operations are extracted or mined and transported as part of the mining or extracting process 100 to the feed location of the iron ore tailings processing system 102. Mining or extracting the low grade iron ores or tailings from their location and transporting them to a new location are generally known to the mining industry. It is also noted that, depending on the location of the low grade iron ore deposits or iron ore tailings, the iron ore tailings processing system 102 can be located where the deposits or tailings exist in order to reduce extraction and transportation costs. After feeding the iron ore tailings to the processing system 102, the tailings are then provided to the one or more screens 110.

The one or more screens 110 separate the iron ore tailings into two, three or more different sizes to ensure that the tailings to be processed through the gravity separators 130 are within certain size range. There are different types of screens used in the mining and aggregate industry, including grizzly separators, vibratory rock screens, rotating drum screens, finger screens, and banana screens. In an exemplary embodiment, the one or more screens 110 may segregate the material into four sizes: 0-3 millimeters (mm), 3-6 mm, 6-10 mm, and greater than 10 mm. The larger fraction that is screened can be processed through a size reduction process 120. The size reducer 120 may comprise a vertical impact crusher or similar equipment known in the art and is generally relied upon to reduce the sizing of byproduct particles. Other examples of size reducers 120 include jaw crushers, cone crushers, and hammer mills. As noted above, the size reducer 120 may be omitted in certain embodiments. The performance of the gravity separation tables or water pulsating separators 130, which receives the different iron ore tailings fractions from the screen or screens 110, is optimized for particles that are uniform in size and 10 mm or less in size. Alternatively, the screen or screeners 110 may be set in parallel or in series in order to operate at a different rate or speed and increase the performance of the screening process.

The determination of whether to screen the material into finer such ranges, for example, 0-1 mm, 1-4 mm, 4-6 mm, or other sizes, may depend on the make-up of the material being process. As mentioned above, such size ranges will be fed separately to the density separators 130 such as vacuum or pressure gravity separation air tables and water pulsating separators.

One type of density separator 130 is a gravity separation table. A gravity separation table includes a vibrating, screen-covered deck that is positioned on an incline, such that the deck slopes down in one direction. Granular material, such as the iron ore tailings, is introduced onto the deck as it vibrates. The screen of the deck allows air to flow up from beneath the deck. This air flow causes light components of the processed material to float over the surface of the deck in a stratified mass. The heavier components of the processed material remain close to or on the deck. The vibration and air flow actions cause the lighter strata to move down the inclined deck of the gravity separation table while the heavy strata move up the incline. In this way, a heavy fraction of the material can be collected at the upper end of the inclined deck while a light fraction can be collected at the lower end of the inclined deck.

The gravity separation tables 130 may be a pressure-type or vacuum-type design. A pressure-type gravity separation table pushes air up through the screen of the deck, creating a positive pressure over the deck. This is accomplished such as by positioning a fan under the deck structure of the gravity separation table. Typically, the pressure-type gravity separation table has an open deck. A vacuum-type gravity separation table creates a vacuum over the deck, creating a suction that pulls air through the screen of the deck. A vacuum-type gravity separation table is enclosed with an air source downstream of the gravity separation table deck.

An exemplary water pulsating type density separator 130 includes a screen immersed in a tank of liquid (typically water). The liquid level is above the level of the screen. The iron ore tailings are added to the water pulsating separator such that the iron ore tailings are deposited onto the screen at one end of the separator. The screen has openings that allow the liquid to move through the screen, while the screen supports the iron ore tailings. The separator 130 causes the liquid to pulse up and down through the openings of the screen. This pulsating action causes the iron ore tailings to fluidize. As the iron ore tailings move down the screen from one end in a direction away from the chute where the tailings were added to the separator 130, the tailings particles separate based on their relative densities. The heavier materials settle in layers near the surface of the screen while the lighter materials stratify near the surface of the liquid, above the layers of heavier particles.

The water pulsating type density separator 130 includes two chutes at the end of the screen bed opposite the end where the iron ore tailings were added to the separator 130. These chutes are positioned such that the heavy material exits the separator 130 at one chute and the light material exits the separator 130 at the other chute. The chute for the lighter material includes a rotary valve or the like that allows material to exit the separator 130 but seals the chute such that water does not significantly flow out of the chute. Alternatively, the lighter material may be deposited into the tank of water, where the lighter material is extracted through an opening at the bottom of the tank.

Vacuum and pressure gravity separation air tables and water pulsating separator generally offer long service life and fast and reliable performance. Separator tables, such as the vacuum or pressure gravity separation tables 130, may be generally adjusted for deck vibration speed, air flow, pressure, suction, feed elevation, and pitch, for example, to separate particles on the basis of different specific gravities within certain ranges. By placement of dividers on the tables or water pulsating separator 130, particles having different specific gravities can be separated from lightest to heaviest. The gravity separation tables 130 permit a complete and accurate density classification from the very lightest to the very heaviest of particles in the feed material stream, such as the iron ore tailings material. Other iron ore beneficiation techniques mentioned above were not capable of cost-effectively generating a heavy media separation for specific gravities higher than 3.0. For example, among the iron ore tailings material elements, the specific gravity of iron ranges from about 7.0 to 7.7 (i.e., greater than 7), the specific gravity of silica ranges from about 2.1 to 2.6, taconite ranges from 2.8 to 3.0 and magnetite 3.5 up to 5.1. With such varying specific gravities, preferred beneficiation techniques were not capable of cost-effectively generating an iron ore concentrate with an iron content higher than 50%.

Because separator air tables and water pulsating separators are able to effectively separate particles having specific gravities of one unit of measure difference, for example, good separation between iron, with a specific gravity of greater than 7, and anthracite, with a specific gravity from about 1.1 to 1.6, is possible with the vacuum or pressure gravity separation tables 130. Based on the difference in specific gravity among the elements in the byproduct material provided to the density separators 130, the byproduct material processed in the density separations 130 can be separated to provide separate high iron content ores from low grade iron content rocks. The iron ore concentrate may be grade to sell because of its high iron content of about 50 percent iron or greater, or it can be further processed through a color sorter separator 140 to sort the darker rocks, which are known to have higher iron content, from lighter color rocks such as beige or gray. A color separator is a machine commonly employed in the bulk materials industries (such as food) that distinguishes the different colors of materials moving along a conveyor and separators the materials based on their color. The machines are typically based on optical camera systems that record images that are analyzed to distinguish the colors of items in the images. The location of items in the image is then associated with a location on the conveyor such that the item can be removed from the material stream, such as by using an air jet.

By processing the iron ore tailings through the system 102, the low grade iron ore with iron contents of 10-15 percent are then converted into an iron ore concentrate of 50 percent or higher iron content.

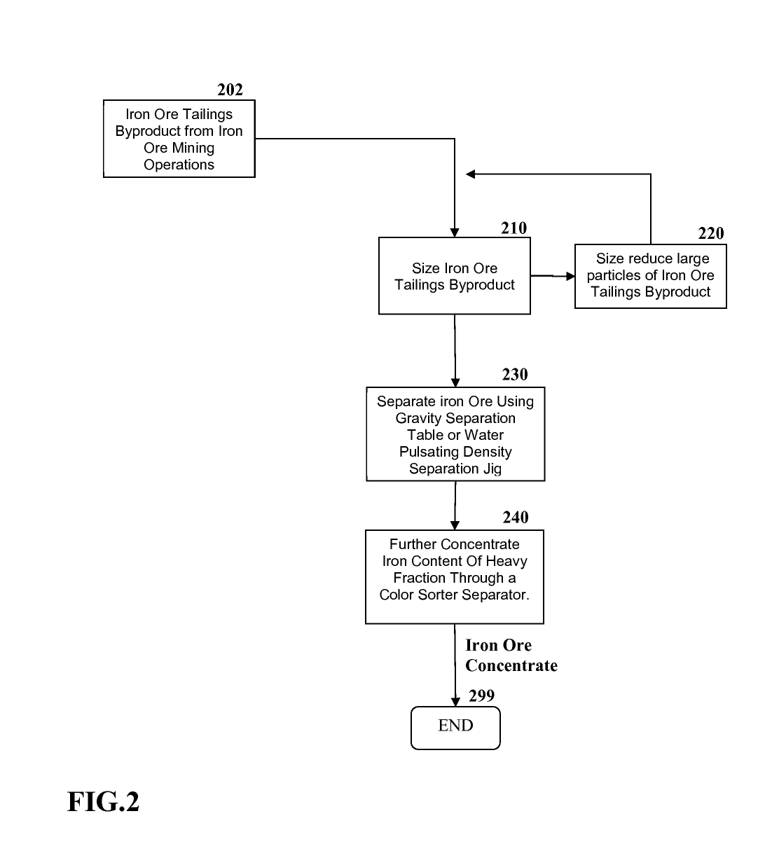

FIG. 2 illustrates a method 200 to of processing low grade iron ore tailings. At step 210 iron ore tailings are screened through one or more screens into different discrete size ranges. The oversize fraction of the screening process can then be further size reduced at step 220 to be rescreened. Such size reduction step can be omitted such that the oversized fraction is not reprocessed through the system. The smaller size fraction or fractions are then processed through a density separator at step 230 such as by using a gravity air table or pulsating water gravity separator. Such process generates a “heavy fraction” which is can be consider “grade to sell” iron ore with iron content of 50 percent or higher. If needed, such heavy fraction can be processed through a color sorter separator at step 240 to further increase the iron content of the heavy fraction.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed is:

1. A method for processing low grade iron ores, comprising the steps of:
receiving iron ore tailings;
separating the iron ore tailings into two or more groups based on sizes of the iron ore tailings, each group comprising a respective portion of the iron ore tailings; and
processing the respective portion of the iron ore tailings in at least one group using a density separation process to generate iron ore concentrate.

2. The method of claim 1, wherein the step of processing the iron or tailings using the density separation process comprises using a pulsating water density separator.

3. The method of claim 1, wherein the step of processing the iron or tailings using the density separation process comprises using a gravity separation table.

4. The method of claim 3, wherein the gravity separation table is a pressure-type gravity separation table.

5. The method of claim 3, wherein the gravity separation table is a vacuum-type gravity separation table.

6. The method of claim 1, further comprising a step of processing the iron ore concentrate to produce higher iron content iron ore concentrate.

7. A system for processing an iron ore tailings byproduct, comprising:
a source of the iron ore tailings byproduct;
a screen that separates the iron ore tailings into groups of different size particles;
a density separator to separate at the different size particles in at least one group to generate an iron ore concentrate.

8. The system of claim 7, further comprising a color sorter separator to process the iron ore concentrate to produce higher iron content iron ore concentrate.

9. The system of claim 7, wherein the density separator comprises a gravity separation table.

10. The system of claim 9 wherein the gravity separation table is a pressure-type gravity separation table.

11. The system of claim 9 wherein the gravity separation table is a vacuum-type gravity separation table.
